(19) United States
(12) Patent Application Publication
(10) Pub. No.: US 2006/0202064 A1
(43) Pub. Date: Sep. 14, 2006

(54) Bundle of nozzles for vacuum packaging

(76) Inventor: Joon-Yeong Ahn, Ansan-city (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/550,307

(22) PCT Filed: Aug. 22, 2003
(86) PCT No.: PCT/KR03/01698

§ 371 Date: Sep. 22, 2005

(30) Foreign Application Priority Data
Mar. 22, 2003 (KR) 20-2003-0008616

(51) Int. Cl. B05B 1/18

(52) U.S. Cl. 239/567; 239/548; 239/589

(57) ABSTRACT

Disclosed are a bundle of nozzles for vacuum sealing a plastic bag that are inserted into the plastic bag to form air discharging passages by the coupling to one another and are then heat sealed together with the plastic bag. The bundle of nozzles of this invention include a plurality of nozzles being made of a heat sealable material in order to be inserted into the plastic bag and heat sealed together with the plastic bag, wherein the plural nozzles are coupled to one another along the outer peripheral surfaces thereof, thereby providing the air discharging passages from the plastic bag.

### TECHNICAL FIELD

The present invention relates to a bundle of nozzles for vacuum sealing a plastic bag that are inserted into the plastic bag to form air discharging passages by the coupling to one another and are then heat sealed together with the plastic bag.

### BACKGROUND ART

Generally, plastic bags in which foods for storage are placed are vacuumed and sealed by a vacuum sealing apparatus, in order to keep the foods fresh.

As one of the prior arts, there is disclosed Korean Patent Application No. 92-0700998 entitled ‘An apparatus for vacuum sealing plastic bags’, which is illustrated in FIG. 1a. The conventional plastic bag 21 is provided with an embossing part 25 that is formed on the inner surface thereof in order to serve as air discharging passages at the time of sealing the plastic bag. The plastic bag 21 is vacuumed and heat sealed by using the apparatus 20 as shown in FIG. 1b.

In more detail, the conventional apparatus 20 for vacuum sealing the plastic bag 21 includes a base 32, a hood 33, a vacuum chamber 34 that is located between the base 32 and the hood 33, a vacuum pump (which is not shown in the drawing) adapted to vacuum a vacuum chamber 34, and a heat sealing part 50 for sealing the opening portion of the plastic bag 21.

In case of vacuum sealing the plastic bag 21 by using the conventional apparatus 20, articles like foods are first placed into an appropriate location on the inside of the plastic bag, and the opening portion of the plastic bag 21 is located on the interior of the vacuum chamber 34. Next, the hood 33 is descended above the base 32, such that the plastic bag 21 and the vacuum chamber 34 are all closed. If a predetermined switch is manipulated to operate the vacuum pump, then, the vacuum chamber 34 gets vacuumed by the operation of the vacuum pump, which enables the air in the interior of the plastic bag 21 to be removed therefrom. Finally, the opening portion of the plastic bag 21 is heat sealed by means of the heat sealing part 50. At that time, the formation of the embossing part 25 on one inside of the plastic bag 21, as shown in FIG. 1a, allows the air filled in the interior of the plastic bag 21 to be absorbed and removed.

However, the conventional chamber type apparatus for vacuum sealing the plastic bag needs the embossing part that is fabricated at a high cost. In addition, the embossing part may be broken by means of a pair of rollers that have been heated during its manufacturing process, which makes the number of bad plastic bags substantially increase.

On the other hand, there is another conventional apparatus for vacuum sealing the plastic bag that is employed with a nozzle. In this case, the nozzle is inserted in the interior of the plastic bag at the time of providing vacuum to the plastic bag and after the vacuum procedure is completed, it should be separated from the plastic bag. At that time, however, a number of complicated devices for controlling the position of the nozzle are needed during the vacuum sealing procedure and during the heat sealing.

There is still another conventional apparatus for vacuum sealing the plastic bag, wherein the portion of the plastic bag that is located on the front of the nozzle is heat sealed, but in this case, the nozzle is placed on the opening portion of the plastic bag such that local air traps may be formed, which of course makes it difficult to seal the plastic bag well. Moreover, there occurs a problem that the length of the plastic bag corresponding to the depth of the nozzle inserted in the interior of the plastic bag is consumed unnecessarily.

### DISCLOSURE OF INVENTION

Therefore, the present invention has been made in view of the above-described problems and it is an object of the present invention to provide a bundle of nozzles for vacuum sealing a plastic bag that are provided with a plurality of nozzles that are inserted and heat sealed together with the plastic bag, without any formation of an embossing part on the inside of the plastic bag.

It is another object of the present invention is to provide a bundle of nozzles for vacuum sealing a plastic bag that are heat sealed together with the opening portion of the plastic bag after a vacuuming procedure.

It is still another object of the present invention is to provide a bundle of nozzles for vacuum sealing a plastic bag that do not generate local air traps, thereby achieving a substantially rapid vacuum procedure.

It is still yet another object of the present invention is to provide a bundle of nozzles for vacuum sealing a plastic bag, wherein each has a plurality of break lines on the outer peripheral surface thereof, thereby being cut to a predetermined desired length, without any unnecessary consumption.

To accomplish the above objects, according to the present invention, there is provided a bundle of nozzles for vacuum sealing a plastic bag, which includes a plurality of nozzles made of a heat sealable material in order to be inserted into the plastic bag and heat sealed together with the plastic bag, the plurality of nozzles being coupled to one another along the outer peripheral surfaces thereof so that first air discharging passages are formed near a coupling portion between two adjacent nozzles.

Preferably, each of the plural nozzles has an embossing part formed on the peripheral surface thereof, so that second air discharging passages are formed on the peripheral surface of the each nozzle.

Also, the embossing part serves as air discharging passages from the plastic bag, in the form of continuous channels or dispersed protruding objects, on the inner or outer peripheral surface of the each nozzle. And, each of the plural nozzles has a plurality of break lines formed at predetermined regular intervals on the outer periphery surface thereof, for cutting the each nozzle to a predetermined length. Preferably, each of the plural nozzles has a plurality of through holes formed on the outer peripheral surface thereof, thereby preventing the generation of local air traps and allowing a vacuuming procedure to be achieved at a substantially rapid speed. On the other hand, the bundle of nozzles are fabricated in the manner of being first made individually and then coupled to one another, or in the manner of being made coupled as a bundle in an injection molding manner.

### BRIEF DESCRIPTION OF THE DRAWINGS

Further objects and advantages of the invention can be more fully understood from the following detailed description taken in conjunction with the accompanying drawings, in which:

FIG. 1a is a perspective view showing a conventional plastic bag on which an embossing part is formed on the inside thereof;

FIG. 1b is a perspective view showing the sealing method embodied with the conventional plastic bag with the embossing part on the inside thereof;

FIG. 2 is an enlarged perspective view showing a part of the bundle of nozzles for vacuum sealing a plastic bag according to a first embodiment of the present invention;

FIG. 3 is an enlarged sectional view taken along the line A-A of FIG. 2;

FIG. 4 is an enlarged perspective view showing a part of the bundle of nozzles for vacuum sealing a plastic bag according to a second embodiment of the present invention;

FIG. 5 is an enlarged sectional view taken along the line B-B of FIG. 4;

FIG. 6 is an enlarged perspective view showing a part of the bundle of nozzles for vacuum sealing a plastic bag according to a third embodiment of the present invention;

FIG. 7 is an enlarged sectional view taken along the line C-C of FIG. 6;

FIG. 8 is an enlarged perspective view showing a part of the bundle of nozzles for vacuum sealing a plastic bag according to a fourth embodiment of the present invention;

FIG. 9 is a perspective view showing the bundle of nozzles for vacuum sealing a plastic bag according to the principles of the present invention;

FIG. 10 is a perspective view showing the bundle of nozzles of the present invention that is heat sealed together with the plastic bag;

FIG. 11 is an enlarged perspective view showing a part of the bundle of nozzles for vacuum sealing a plastic bag according to a fifth embodiment of the present invention; and

FIG. 12 is an enlarged sectional view taken along the line D-D of FIG. 11.

### BEST MODE FOR CARRYING OUT THE INVENTION

Now, an explanation of the preferred embodiments of the present invention will be given hereinafter.

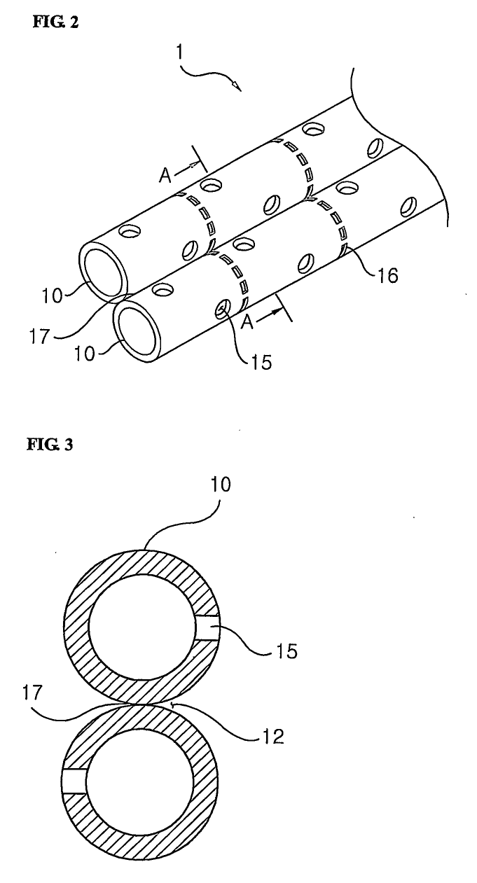

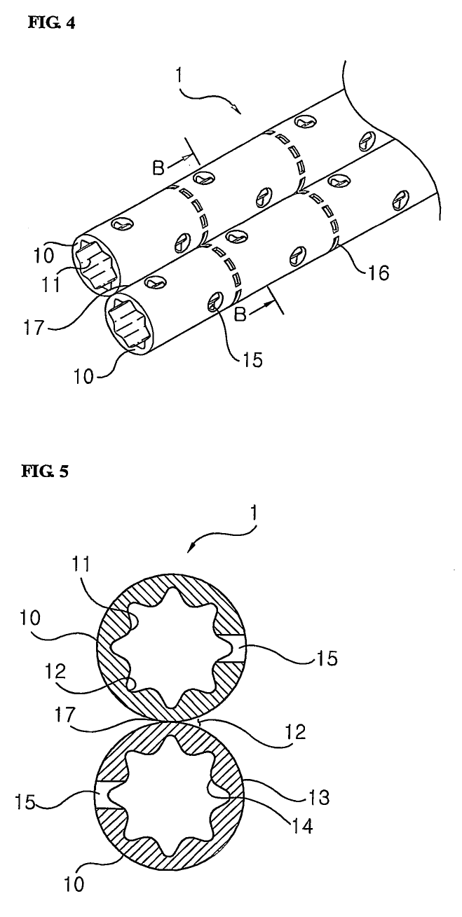

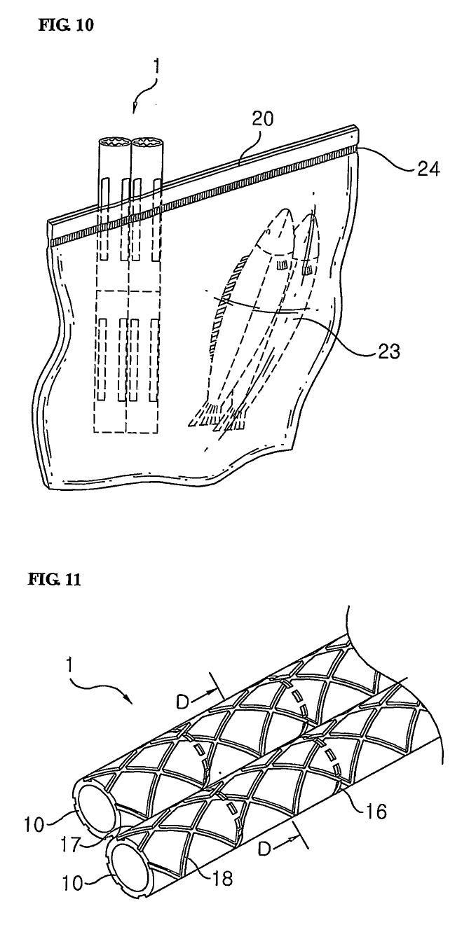

FIGS. 2 and 3 show a bundle of nozzles 1 for vacuum sealing a plastic bag according to a first embodiment of the present invention. The bundle of nozzles 1 of this preferred embodiment are made of a heat sealable material and include two nozzles 10 coupled to each other along the outer peripheral surfaces thereof. Along a coupling portion 17 of the nozzles 10 are formed air discharging passages 12 from the plastic bag 20. In case where the bundle of nozzles 1 are inserted into the plastic bag 20 (see FIG. 10) and compressed, thus, the air discharging passages 12 are maintained thus to extract the air in the plastic bag 20 therefrom. After this vacuuming step, the bundle of nozzles 1 are heat sealed together with the plastic bag 20 by the operation of a heat sealing part 24.

Each of the nozzles 10 is made of a heat sealable material such as polyethylene, a high density of polyethylene, polypropylene and so on, and has a thickness of tens of μm, which is appropriately the same as the plastic bag 20, so that it can be easily sealed together with the plastic bag 20. Their inner and outer peripheral surfaces (14 and 13) are of a flat type, without any concave/convex patterns. For example, the nozzles 10 may have a shape of a generally drinking straw.

Each of the nozzles 10 is sufficiently long but it is easily cut on the break lines 16 if necessary. In some cases, the nozzles 10 may be fabricated to a predetermined desired length allowing the insertion into the plastic bag 20, with no break line.

As noted earlier, the break lines 16 are located on the outer peripheral surface of the each nozzle so that the nozzle can be easily cut to a desired length. So, the lengths of the bundle of nozzles 10 are adjustable depending upon the sizes of the plastic bag 20. Thus, the bundle of nozzles 1 are supplied in a sufficiently long length like a roll of nozzles, and if necessary, they are cut to their predetermined break line. Desirably, the break lines 16 are in the shape of a broken line or are cut by half thickness of the nozzle 10.

On the other hand, each of the nozzles 10 is provided with a plurality of through holes 15 on the outer peripheral surface thereof, for the purpose of rapidly discharging the internal air of the plastic bag 20 and preventing the generation of local air traps. The plurality of through holes 15 are substantially elongated slots through which the air flow occurs, and they are located on the outer peripheral surface of the nozzle 10.

FIGS. 4 and 5 show a bundle of nozzles 1 for vacuum sealing a plastic bag according to a second embodiment of the present invention. The bundle of nozzles 1 of this preferred embodiment include two nozzles 10 coupled to each other along the outer peripheral surfaces thereof, like the first embodiment. However, each of the nozzles 10 in this second embodiment is provided with an embossing part 11 on the inner peripheral surface 14 thereof, thereby providing another air discharging passages 12 from the plastic bag 20.

The embossing part 11 is of a concave/convex shape on the inner peripheral surface 14 of the nozzle 10, such that the air discharging passages 12 are continuously formed along the length directions of the nozzles 10. With the embossing part 11, in case where the bundle of nozzles 1 are inserted into the plastic bag 20 and then compressed by the external force like a packing part of a vacuum sealing apparatus (not shown), the air discharging passages 12 are maintained thus to extract the air in the plastic bag 20 therefrom. The embossing part 11 may be in the form of dispersed protruding objects on the inner peripheral surface 14 of the nozzle 10.

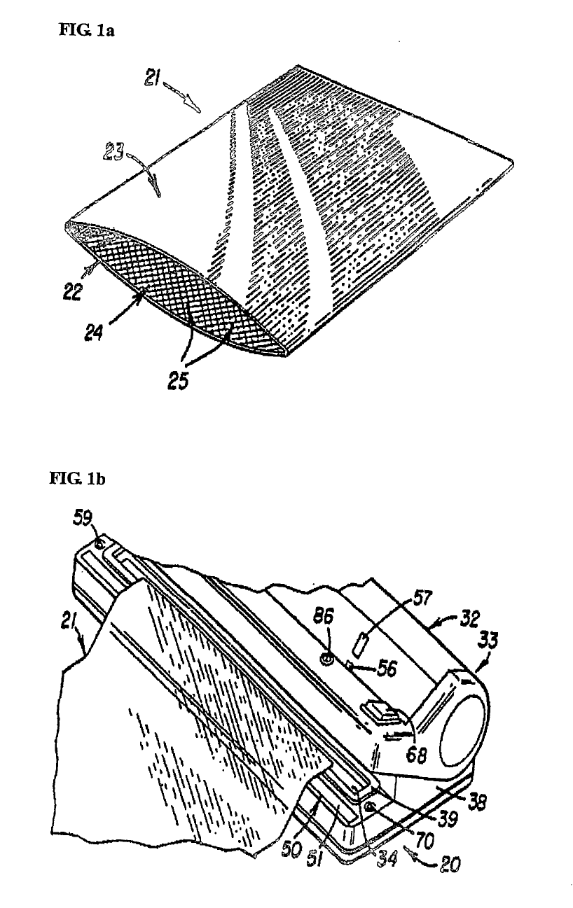

After this vacuuming step in the state of being inserted into the plastic bag 20, the bundle of nozzles 1 are heat sealed together with the plastic bag 20 by the operation of the heat sealing part 24. Thus, the bundle of nozzles of this invention can be applied both to the chamber type vacuum sealing apparatus (see FIG. 1b) and the nozzle type vacuum sealing apparatus (not shown). At this time, in case of the nozzle type vacuum sealing apparatus, the bundle of nozzles of this invention are adapted to be mounted on the nozzles in the apparatus in order to provide the air discharging passages from the plastic bag 20, such that the plastic bag 20 is vacuumed and heat sealed.

In the same manner as in the first embodiment, each nozzle is made of a heat sealable material and has the plurality of break lines 16 and the plurality of through holes 15 when necessary.

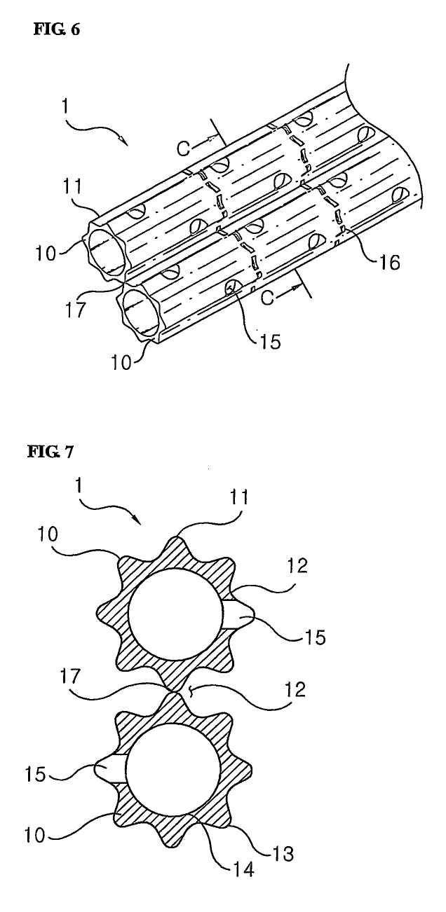

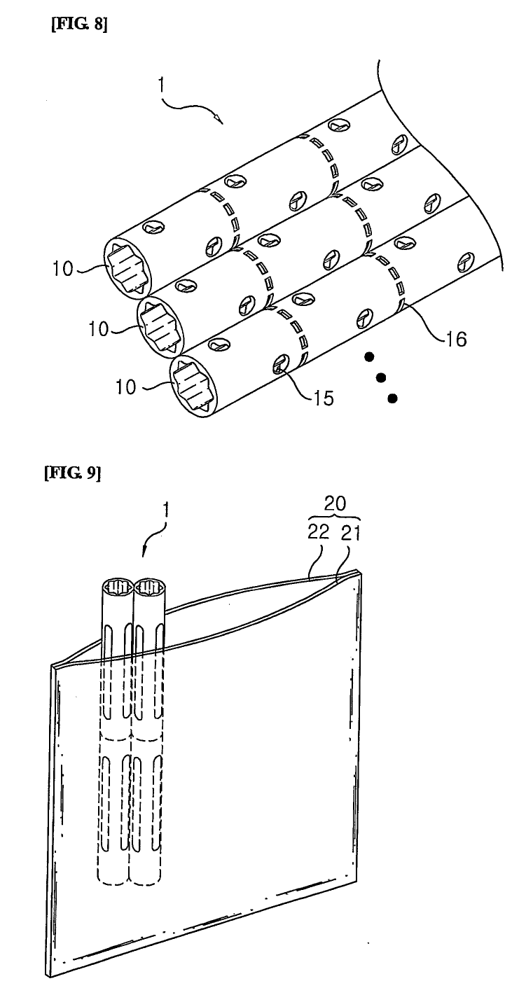

FIGS. 6 and 7 show a bundle of nozzles 1 for vacuum sealing a plastic bag according to a third embodiment of the present invention. The bundle of nozzles 1 of this preferred embodiment include two nozzles 10 coupled to each other along the outer peripheral surfaces threof, like the first embodiment. However, each of the nozzles 10 in this third embodiment is provided with an embossing part 11 on the outer peripheral surface 13 thereof, thereby providing another air discharging passages 12 from the plastic bag 20.

The embossing part 11 is of a concave/convex shape on the outer peripheral surface 13 of the nozzle 10, such that the air discharging passages 12 are continuously formed along the length directions of the nozzles 10. With the embossing part 11, in case where the bundle of nozzles 1 are inserted into the plastic bag 20 and then compressed by the external force like a packing part of a vacuum sealing apparatus, the air discharging passages 12 are maintained thus to extract the air in the plastic bag 20 therefrom. The embossing part 11 may be in the form of dispersed protruding objects on the outer peripheral surface 13 of the nozzle 10. Preferably, a coupling portion 17 is formed by the connection with the embossing parts 11 of the nozzles 10, thereby making the bundle of nozzles 1 easily fabricated at a time in an injection molding manner.

In the same manner as in the first embodiment, each nozzle is made of a heat sealable material and has the plurality of break lines 16 and the plurality of through holes 15 when necessary.

FIG. 8 shows a bundle of nozzles 1 for vacuum sealing a plastic bag according to a fourth embodiment of the present invention. The bundle of nozzles 1 of this preferred embodiment include three or four or more nozzles 10 coupled to one another along the outer peripheral surfaces thereof, like the first embodiment. Therefore, along the coupling portion 17 between adjacent nozzles 10 are formed air discharging passages 12 from the plastic bag 20. In case where the bundle of nozzles 1 are inserted into the plastic bag 20 and then compressed, the air discharging passages 12 are maintained thus to extract the air in the plastic bag 20 therefrom. After this vacuuming step, the bundle of nozzles 1 are heat sealed together with the plastic bag 20.

In the same manner as in the first embodiment, each nozzle is made of a heat sealable material, and preferably, if the embossing part 11 is needed, it is formed on the peripheral surface of the nozzle 10, thereby providing another air discharging passages 12 from the plastic bag 20. The embossing part 11 may be in the form of continuous channels or dispersed protruding objects, on the inner peripheral surface 14 or the outer peripheral surface 13 of the nozzle 10. Also, the nozzle 10 has the plurality of break lines 16 and the plurality of through holes 15 when necessary.

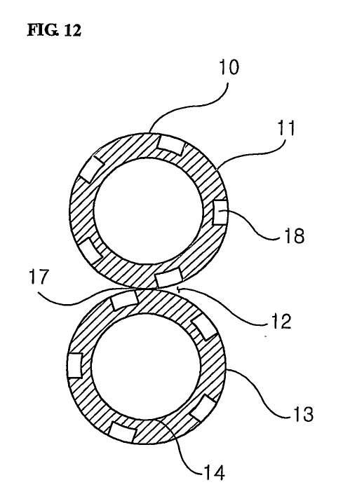

FIGS. 11 and 12 show a bundle of nozzles 1 for vacuum sealing a plastic bag 20 according to a fifth embodiment of the present invention. The bundle of nozzles 1 of this preferred embodiment include two nozzles 10 coupled to each other along the outer peripheral surface thereof, like the first embodiment. However, each of the nozzles 10 in this third embodiment is provided with the embossing part 11 on the outer peripheral surface 13 thereof, thereby providing another air discharging passages 12 from the plastic bag 20. In this preferred embodiment, the embossing part 11 is formed of continuously arranged grooves 18.

The embossing part 11 is of a concave/convex shape on the outer peripheral surface 13 of each nozzle 10, such that the grooves 18 that are formed along the length direction of each nozzle 10 serve as the air discharging passages 12 from the plastic bag 20. With the embossing part 11, in case where the bundle of nozzles 1 are inserted into the plastic bag 20 and then compressed by the external force like a packing part of a vacuum sealing apparatus, the air discharging passages 12 are maintained thus to extract the air in the plastic bag 20 therefrom.

In the same manner as in the first embodiment, each nozzle is made of a heat sealable material and has the plurality of break lines 16 and the plurality of through holes 15 when necessary.

As shown in FIGS. 9 and 10, the bundle of nozzles 1 of this invention are inserted into the plastic bag 20. The plastic bag 20 includes an upper panel and a lower panel and is formed of a heat sealable material.

The articles 23 like foods for storage are placed into the plastic bag 20, and the bundle of nozzles 1 of this invention are inserted into the plastic bag 20. After that, the plastic bag 20 is placed at a predetermined location of the vacuum sealing apparatus as shown in FIG. 1b, and as the hood of the apparatus is closed, the opening portion of the plastic bag 20 is tightly closed. In this case, however, the air discharging passages 12 located on the coupling portion 17 of the bundle of nozzles 1 of this invention are maintained such that the air in the plastic bag 20 is completely removed. After the vacuuming step, the opening portion of the plastic bag 20 is heat sealed together with the bundle of nozzles 1 by the operation of the heat sealing part 24, thereby completing the vacuum sealing procedure.

### INDUSTRIAL APPLICABILITY

As set forth in the foregoing, the bundle of nozzles of this invention can be provided at a substantially low cost and at a high efficiency, without any formation of an embossing part on the inside of the plastic bag.

In addition, the bundle of nozzles of this invention can be heat sealed together with the opening portion of the plastic bag after the completion of the vacuuming procedure, thereby making it convenient to use.

The bundle of nozzles of this invention can be provided with the embossing part that provides additional air discharging passages, permitting the vacuuming step to be completed at a substantially fast speed, whereby they can be applied to chamber type vacuum sealing apparatuses as well as nozzle type vacuum sealing apparatuses.

Also, the bundle of nozzles of this invention can be provided with the plurality of through holes, so that the generation of local air traps can be prevented and the vacuuming step can be achieved at a substantially fast speed.

The bundle of nozzles of this invention can be provided with the plurality of break lines, so that the nozzles are supplied as a roll of nozzles and are cut to a predetermined desired length, without any unnecessary consumption.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

1. A bundle of nozzles for vacuum sealing a plastic bag, the bundle of nozzles comprising a plurality of nozzles made of a heat sealable material in order to be inserted into the plastic bag and heat sealed together with the plastic bag, the plurality of nozzles being coupled to one another along the outer peripheral surfaces thereof so that first air discharging passages are formed near a coupling portion between two adjacent nozzles.

2. The bundle of nozzles according to claim 1, wherein each of the plural nozzles has an embossing part formed on the peripheral surface thereof, so that second air discharging passages are formed on the peripheral surface of the each nozzle.

3. The bundle of nozzles according to claim 2, wherein the embossing part is formed on the inner peripheral surface of the each nozzle.

4. The bundle of nozzles according to claim 1, wherein each of the plural nozzles has a plurality of break lines formed at predetermined regular intervals on the outer periphery surface thereof, for cutting the each nozzle to a predetermined length.

5. The bundle of nozzles according to claim 1, wherein each of the plural nozzles has a plurality of through holes formed on the outer peripheral surface thereof.

6. The bundle of nozzles according to claim 2, wherein each of the plural nozzles has a plurality of through holes formed on the outer peripheral surface thereof.

7. The bundle of nozzles according to claim 3, wherein each of the plural nozzles has a plurality of through holes formed on the outer peripheral surface thereof.

8. The bundle of nozzles according to claim 4, wherein each of the plural nozzles has a plurality of through holes formed on the outer peripheral surface thereof.
